(19) United States
(12) Patent Application Publication
(10) Pub. No.: US 2010/0146337 A1
(43) Pub. Date: Jun. 10, 2010

(54) METHOD AND DEVICE FOR DETECTING NON-REGRESSION OF AN INPUT/OUTPUT SYSTEM IN A SIMULATION ENVIRONMENT

(75) Inventors: Frank DESSERTENNE, Colomiers (FR); Jean Francois Copin, Toulouse (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: Airbus Operations SAS, Toulouse Cedex (FR)

(21) Appl. No.: 12/635,194

(22) Filed: Dec. 10, 2009

(30) Foreign Application Priority Data
Dec. 10, 2008 (FR) 08 58446

(51) Int. Cl. G06F 11/28

(52) U.S. Cl. 714/27; 714/E11.178

(57) ABSTRACT

The object of the invention is in particular a method and a device for detecting non-regression of an input/output system from a remote station comprising a test tool adapted for executing a test command of the said input/output system. The said input/output system and remote station are each connected to a communication network. The method comprises transmitting (305), to the said remote station, an instruction to run the said test tool and an instruction to execute the said test command (320), as well as transmitting (315), to a recording device connected to the said communication network, an instruction to record data corresponding to the result of execution of the said command, circulating on the said communication network. After reception, the recorded datum may be analyzed (335) according to a reference datum corresponding to the expected result of execution of the said command.

The present invention relates to testing of systems in a simulation environment and more particularly to a method and a device for detecting non-regression of an input/output system in a simulation environment.

Simulation of the integration of components in a vehicle, in particular in an aircraft, is used especially to ensure the development and integration of the electronic and/or computer systems on board same.

Thus, the integration of components in vehicles is the subject of simulations according to which input/output electronic devices, or input/output cards, are used as an interface between the real components of the vehicle, such as, for example, computers, sensors and drives, and a simulation environment generally comprising one or more servers or computers used to simulate the performance of the vehicle or of a part thereof. Each input/output card has a given number of input paths and output paths.

The complexity of the simulation environment is linked to that of the set of components of the vehicle being used. In the field of aircraft, it generally is necessary to resort to several computers or servers to simulate the various situations which the components are likely to have to confront. A network, allowing communication between the various computers or servers and the input/output electronic devices, generally is used.

The network formed in this way is, for example, of the “switch fabric” type, based on a switched architecture, that is, the terminal equipment items responsible for the transmission and reception of data are organized around switches responsible for the transport of these data. The switch is responsible for transmitting in parallel requests originating from computers or from servers to input/output cards and responses originating from input-output cards to the computers or servers. The same request and the same response must be able to be addressed by the switch to several addressees.

The network used can be based on an existing standard, for example the Ethernet standard (IEEE 802.3) which describes a local network protocol with switching of packets.

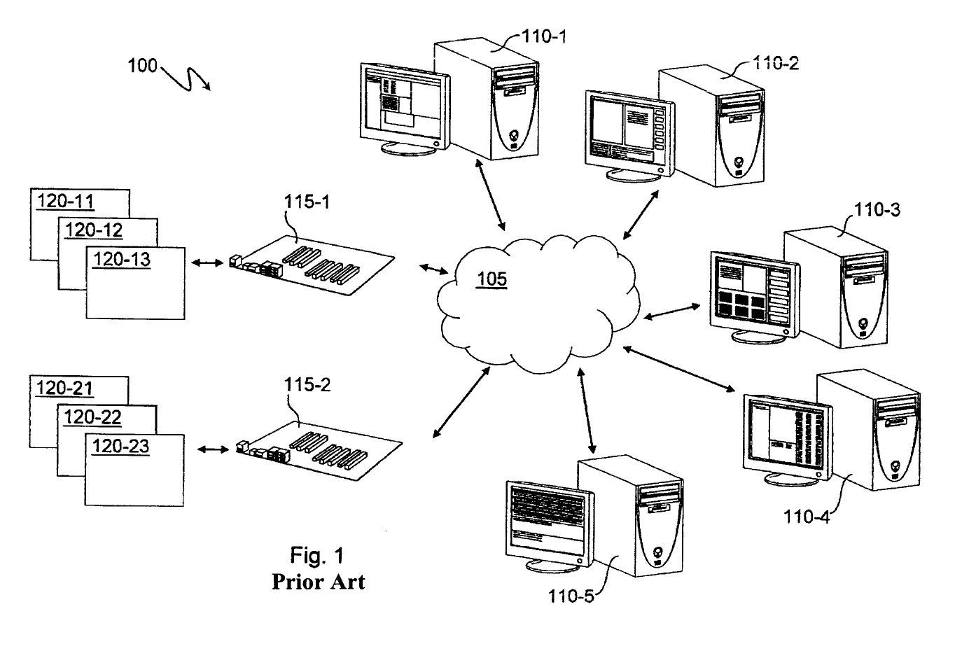

FIG. 1 illustrates an example of an environment that may be used to simulate the integration of components in an aircraft. In this case environment 100 comprises a network 105, to which there are connected computers or servers 110-1 to 110-5 as well as input/output cards 115-1 and 115-2, generically referenced 115. The components whose integration is simulated are in this case components 120-11 to 120-13 and 120-21 to 120-23, generically referenced 120 and connected to input/output cards 115-1 and 115-2 respectively.

Test tools of input/output cards 115 are implemented in computers or servers 110-1 to 110-5, each computer or server being able to implement one or more tools.

To test the configuration of one or more input/output cards 115, an operator uses a test tool implemented on one of computers or servers 110-1 to 110-5 in order to transmit data to one or more input/output cards 115 in the form of requests. The test results, obtained in the form of responses to the requests, are analyzed by the operator, who in this way verifies the progress of the simulation and, as the case may be, detects errors in the configurations of the input/output cards.

When an error is detected, it is corrected in the corresponding input/output card. It is then necessary to repeat the tests, in order to verify the results. However, by reason of the time necessary to perform the tests and consequently of the costs generated, only the tests directly related to the error generally are repeated. It results from these partial tests that if the correction of the error detected in these partial tests has created a new error, the latter may not be detected before the operating phase. Thus there is a regression of the functioning of the input/output system.

The invention makes it possible to resolve at least one of the problems described in the foregoing.

The object of the invention is therefore a computer method for detecting non-regression of an input/output system from at least one remote station comprising at least one test tool, the said at least one test tool being adapted for executing at least one test command of the said at least one input/output system, the said at least one input/output system and the said at least one remote station each being connected to at least one network interface connected to a communication network, this method comprising the following steps,
transmitting, to a recording device connected to the said communication network, an instruction to record at least one datum circulating on the said communication network, the said at least one datum to be recorded corresponding to a result of execution of the said at least one test command of the said at least one test tool;
transmitting, to the said at least one remote station, an instruction to execute the said at least one test command of the said at least one test tool;
receiving the said at least one recorded datum;
receiving at least one reference datum, the said at least one reference datum corresponding to the expected result of execution of the said at least one test command of the said at least one test tool; and
analyzing the said at least one recorded datum according to the said at least one reference datum.

In this way the method according to the invention makes it possible to verify, easily and at low costs, the non-regression of an input/output system in a complex simulation environment employing test tools distributed geographically in a communication network.

According to a particular embodiment, the said analysis step comprises a step of comparing the said at least one recorded datum with the said at least one reference datum.

Advantageously, the method additionally comprises a step of transmitting a configuration instruction to the said at least one remote station in order to configure the said at least one test tool.

Preferably, the method additionally comprises a step of transmitting a configuration instruction to the said recording device in order to configure it. In this way the method according to the invention makes it possible to determine the data to be recorded and to which the analysis of non-regression may be directed.

According to yet another particular embodiment, the method additionally comprises a step of transmitting, to the said at least one remote station, an instruction to run the said at least one test tool.

Advantageously, the method additionally comprises a step of filtering the said at least one recorded datum, the said at least one recorded datum being analyzed in response to the said step of filtering the said at least one recorded datum. In this way the method according to the invention makes it possible to determine the data to which the analysis of non-regression will be directed.

Advantageously, the method additionally comprises a step of filtering the said at least one reference datum, the said at least one recorded datum being analyzed according to the said at least one reference datum in response to the said step of filtering the said at least one reference datum. In this way, the method according to the invention makes it possible to select the reference data used to analyze the non-regression of the input/output system.

According to a particular embodiment, at least one of the said steps is stored in the form of an instruction in a file of XML type, the interpretation of the said file being independent of the nature of the test commands of the said at least one test tool. In this way the method according to the invention makes it possible to create test files whose interpretation is independent of the architecture of the simulation environment and of the test tools employed.

The invention also has as an object a device comprising means adapted for employing each of the steps of the method described in the foregoing as well as a computer program comprising instructions adapted for employing each of the steps of the method described in the foregoing when the said program is executed on a computer.

Other advantages, objectives and characteristics of the present invention become apparent from the detailed description hereinafter, written by way of non-limitative example, with reference to the attached drawings, wherein:

FIG. 1 shows an example of an environment that can be used to simulate the integration of components in an aircraft;

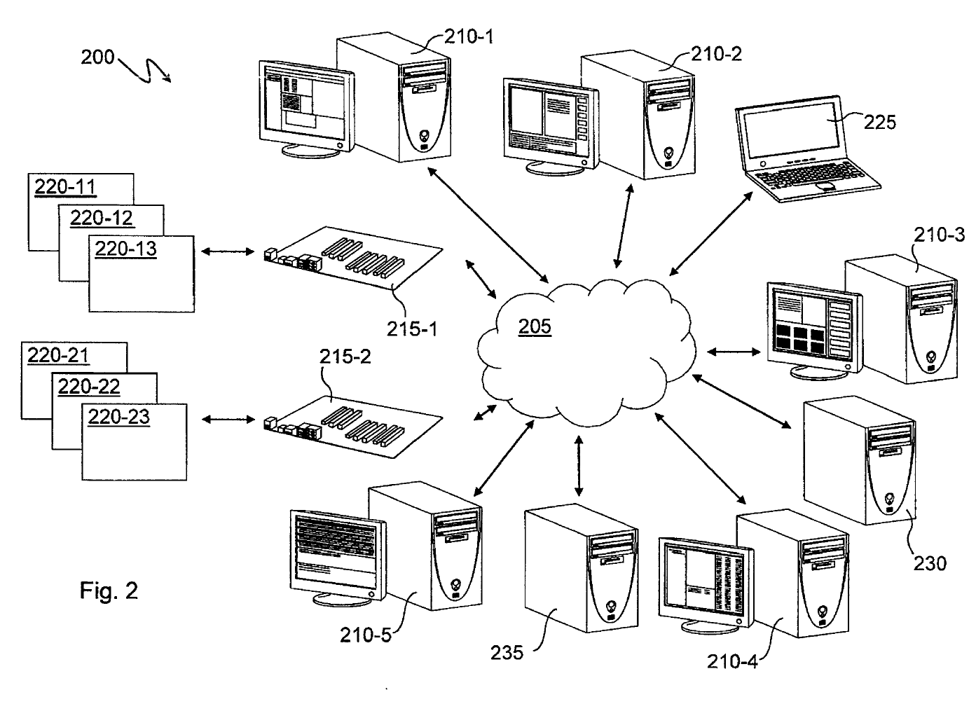

FIG. 2 illustrates an environment that can be used to simulate the integration of components in an aircraft, this environment comprising a system of automatic, non-regressive tests for the simulation of these components;

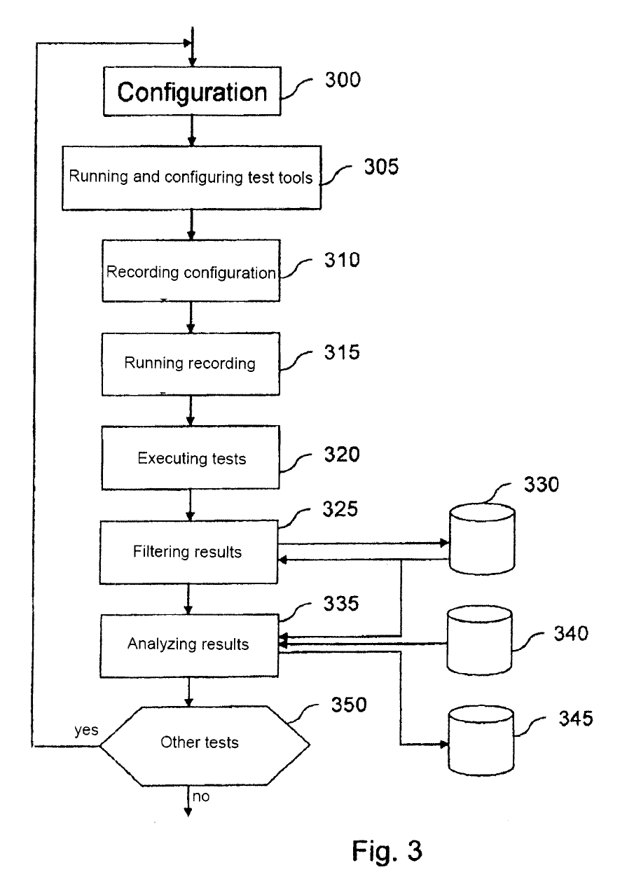

FIG. 3 illustrates an example of an algorithm allowing automatic tests of input/output cards used for simulation of the integration of components to be performed in conformity with the invention;

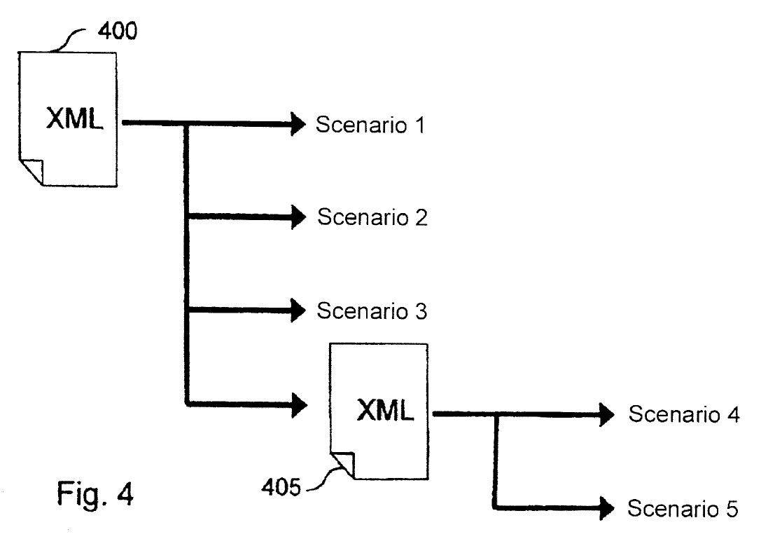

FIG. 4 illustrates an example of a first test sequence that calls up a second test sequence; and

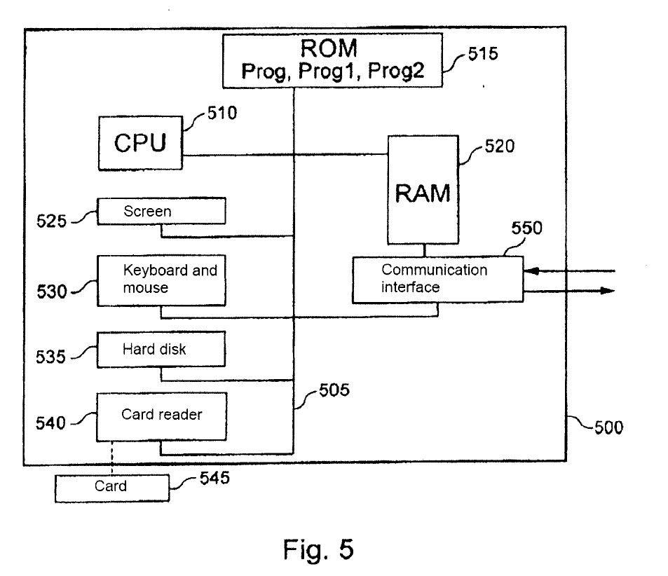

FIG. 5 illustrates an example of a device adapted for employing the invention or part of the invention.

In general, the invention makes it possible to store the results of a test, so that new tests can be automatically performed at a later time and the results obtained can be compared with the results previously stored. In this way the results previously stored constitute reference scenarios, which can also be obtained according to other modes. In particular, these scenarios can be obtained by theoretical means, for example by computation.

FIG. 2 illustrates an environment that can be used to simulate the integration of components in an aircraft, this environment comprising a system of automatic, non-regressive tests of input/output cards used as interfaces with these components.

In common with environment 100 illustrated in FIG. 1, environment 200 in this case comprises a network 205, to which there are connected computers or servers 210-1 to 210-5, generically referenced 210, as well as input/output cards 215-1 and 215-2, generically referenced 215. Once again, the components whose integration is simulated are in this case components 220-11 to 220-13 and 220-21 to 220-23, generically referenced 220, connected to input/output cards 215-1 and 215-2 respectively.

Similarly, the test tools of input/output cards 215 are implemented in computers or servers 210-1 to 210-5, each computer or server being able to implement one or more test tools.

Environment 200 additionally comprises a computer or server 225 adapted for employing a method for automatic, non-regressive tests of input/output cards 215 used for simulation of the integration of components 220. Environment 200 additionally comprises a device 230 for recording data circulating on the network and a storage device 235. As an example, devices 230 and 235 are computers or servers.

Although computer or server 225 is separate from devices 230 and 235 in this case, the functions of these devices can be implemented in computer or server 225. It is also possible to use only one device employing the functionalities of devices 230 and 235.

Device 230 is adapted for recording all of the data circulating on network 205 having predetermined characteristics.

According to a particular embodiment, device 230 comprises a mass storage adapted for recording data, a network interface and processing means adapted for executing a software application for analysis of network data. Such an application is, for example, Wireshark software, whose characteristics are available at the website www.wireshark.org.

Device 235, for example, is composed of a hard disk and a network interface.

According to yet another particular embodiment, computer or server 225 is used to run and monitor the test tools implemented in computers or servers 210-1 to 210-5, in order to monitor the recording of data exchanged on network 205 in device 230 and to analyze data recorded by device 230 according to data previously stored in device 235. The data stored in device 235 are, for example, data recorded in device 230 that have been validated by an operator or automatically.

Advantageously, filtering is applied to the recorded data in order to select those to be analyzed according to data previously stored. A similar filter may be applied to the data previously stored, in order to select those to be used during analysis of the test results.

By way of illustration, the recorded data and those previously stored may be the data transmitted by input/output card 215-1 to computer or server 210-2, input/output card 215-1 and computer or server 210-2 being able to be identified, for example, by their IP (abbreviation for Internet Protocol in English terminology) addresses.

FIG. 3 illustrates an example of an algorithm allowing automatic tests of input/output cards used for simulation of the integration of components to be performed.

A first step (step 300) has the purpose of configuring the test and simulation environment. This step consists, for example, in configuring network 205, in particular of attributing an address to each network element, of establishing the communication channels and protocols used and in powering up the input/output cards. Naturally the configuration step is related to the nature of the simulation being carried out, to the components employed and to other parameters outside the scope of the invention.

After the test environment has been configured, the test tools to be used are run and configured (step 305) to permit subsequent activation of commands of these tools. The configuration of test tools is specific to each tool, and is effected in standard manner, for example by means of a configuration file.

The device for recording data exchanged over the network is then configured (step 310) in order to permit, in particular, identification of data to be recorded. These depend in particular on the nature of the tests performed.

It should be noted that, although the step of configuring the device for recording data is performed in this case after that for the test tools, the order is unimportant. These steps can also be performed simultaneously. In addition, the test tools can be run and configured, as can the recording device, in the course of simulation.

The recording device is then activated (step 315) to run data recording, and the tests are performed (step 320). Once again, it is possible to activate the recording device in the course of simulation in order to target the data to be recorded.

The test results, recorded in this case in 330, are then preferably filtered (step 325), in order to select the data to which the analysis is to be directed. An identical filter may be applied to the reference data previously stored in memory, in this case stored in 340, used during analysis of recorded data.

The test results are then analyzed, for example by comparing the test results recorded and selected with the corresponding reference data previously stored (step 335). The result of the comparison is in this case stored in 345.

Depending on the nature of the tests and the needs of the operators, the analysis results may have several forms.

For example, the results of the analysis may consist of a file in which an indication of failure or success is given for each test result. Alternatively, the analysis results may consist of a file that contains the identifiers of tests that have failed. A date may also be associated with the analysis results.

The process is repeated for each test to be performed (step 350).

Advantageously, the succession of instructions permitting execution of the algorithm described with reference to FIG. 3 is defined in a file that can be easily manipulated by an operator, such as an XML-type file (abbreviation for Extensible Markup Language in English terminology).

The syntax used in this file to describe the test instructions is preferably independent of the test tools employed and of the protocols of the communication network connecting the devices used to achieve the simulation.

Furthermore, the number of instructions that can be used to access the test tools is preferably limited. By way of illustration, the following commands may be used:
“launch” or run in English terminology: the objective of this command is to run a test tool. This command is preferably followed by the identifier of the test tool to be run as well as by possible options. The identifier is, for example, the access path and the name of the test tool. The options are specific to the test tools in question; they concern, for example, identifiers of configuration files of the test tool:
“perform” or do in English terminology: this command makes it possible to execute a command of a previously run test tool. This command is preferably followed by the name of the command to be executed as well as by possible options related to the command in question. Such options may in particular specify an address of an input/output card and a state in which it is to be placed;
“wait until an asynchronous event” or wait for an asynchronous event in English terminology and “wait during a predetermined time” or wait for an amount of time in English terminology: the object of these commands is to suspend execution of the sequence of instructions until the event indicated after the command or during the time specified after it; and
“loop” or loop in English terminology: this command makes it possible to repeat a sequence of instructions. The sequence of instructions is repeated as many times as specified.

In the same way, a limited number of parameters is used for analysis of the results or in other words, for example, for the operations of comparison of the test results obtained with the expected results. Such a set of parameters is, for example, the following:
“raw” or raw in English terminology: this parameter indicates that the data must be compared byte by byte;
“date”: this parameter is used to identify and display a recorded date communicated via the communication network, for example a date corresponding to the detection of an error;
“values” or values in English terminology: this parameter makes it possible to specify a tolerance. For example, if the expected response is 10 with a tolerance of ±1, the results 9 and 11 are not considered to be errors during the analysis, whereas the responses 8 and 12 will be; and
“response time” or response time in English terminology: this parameter makes it possible to apply a tolerance to a response time. This parameter is employed in a manner similar to that of “values” described in the foregoing.

According to yet another particular embodiment, a sequence of instructions may make reference to another sequence of instructions. In this way it is possible to construct test sequences from existing test sequences.

FIG. 4 illustrates an example of a first test sequence that calls up a second test sequence. As illustrated, a test sequence stored in an XML file referenced 400 comprises three test scenarios (scenarios 1, 2 and 3) as well as a reference to a second test sequence. This second test sequence, stored in a second XML file referenced 405, in turn comprises two test scenarios (scenarios 4 and 5).

The instructions of test commands are preferably processed sequentially to permit concatenation of the scenarios.

The test sequences stored in the form of files, for example XML files, may be determined directly by an operator. Alternatively, they may be obtained automatically by conversion from a test-sequence description stored, for example in files of text type.

An example of a test sequence in XML format is provided in the Annex. The object of this example is to illustrate the format of a test-sequence file as well as that of the commands used. The data exchanged between the computer or server interpreting this file, the computer(s) or server(s) hosting the test tools and the input/output cards used as interfaces with the components are in this case transmitted via a network of Ethernet type in the form of UDP frames (abbreviation for User Datagram Protocol in English terminology).

The test sequence described by this file is composed of two distinct scenarios referred to as “scenario 1” and “scenario 2” as well as of a call for another file describing one or more test sequences. These scenarios or calls for scenarios correspond to the tags referred to as TEST_SCENARIO.

The object of this test sequence is to establish a diagnosis of an aircraft flight simulation.

The object of the tag ANALYSIS is to define the characteristics of the data to be analyzed. According to the first scenario, only the data of messages identified as “12345”, of UDP type, of communication port “15000”, whose source IP address is “192.168.1.4” and whose destination IP address is “239.0.0.1” are analyzed.

More particularly, only the 12 bytes (length=“12”) starting from the second byte (offset=“2”) of these data are analyzed, as indicated in the tag FUNCTIONAL.

The tag FRAMES_FILE is used to define the files in which the data are to be recorded, in this case “Scn1\MyFile_record.cap” and “Scn2\MyFile_record.cap” for scenarios 1 and 2 respectively. Similarly, the tag FRAMES_FILE is used to define the reference files containing the data with which the recorded data is to be compared. The reference files in this case are “Scn1 \MyReference_File.cap” and “Scn2\MyReference_File.cap” for scenarios 1 and 2 respectively.

The tag RECORDING_TOOL relates to the device that makes it possible to record data circulating on the communication network, these data being defined according to the conditions given as parameters. The recording device is in this case a software application, Wireshark, which can be run from the locating path “C:\Program Files\Wireshark\tshark.exe”. The options for running this application, “-f “ip proto \udp””, make it possible to filter the data to be recorded. Among the recorded data, only the data corresponding to the parameters defined in the tag ANALYSIS are analyzed.

The tag TEST_TOOL designates a test tool.

The tag RUN makes it possible to run the application VIPERE from the access path “D:\VIPERE.exe” and from the configuration file “test.vpj”.

The tag WAIT_COMPLETION then specifies that it is necessary to suspend execution of the process until reception of the message “CONFIGURATION”. However, the tag WAIT specifies that, beyond a time of “10000”, it is no longer necessary to wait for this message, an error of “time out” type being generated.

The tag DO then makes it possible to transmit the command “MONITOR_ENA” to the test tool. This command in this case is intended to activate (option TRUE) a diagnostic function of the input/output card having the IP address “151.157.005.002”.

Similarly, the tag DO makes it possible to transmit the command ACTIVATION, whose purpose is to switch the test tools and the input/output cards into a mode of active use of components connected to the input/output cards. The transmitted commands are then intended to establish a diagnosis of the input/output card having the IP address “151.157.005.002” and to stop the diagnostic function.

At the end of the scenario, the command NAMES_DEF makes it possible to verify that the input/output card having the IP address “151.157.005.002” is correctly identified at the end of simulation.

The scenario is terminated in this case by stopping the recording device (tag STOP). The recorded data corresponding to the parameters defined in the tag ANALYSIS are automatically analyzed as soon as the recording device is stopped. Alternatively, it is possible to use a specific tag to run the analysis.

As indicated in the foregoing, only the data corresponding to the parameters defined in the tag ANALYSIS are analyzed among the recorded data, or in other words among the data that have circulated on the communication network and whose characteristics correspond to those predetermined in the tag RECORDING_TOOL.

The second scenario has the same syntax for monitoring the test tools as that described with reference to the first scenario.

By way of illustration, however, the test tool VIPERE is run in this case on a remote station having the IP address “192.168.2.2” (<RUN Cmd_Line=“D:\VIPERE.exe@192.168.2.3” Option=“test.vpj”/>).

Furthermore, the recording device is run on a remote station in the course of execution of the simulation.

Finally, after execution of the second scenario, a file of XML type is called to execute other scenarios, in order to illustrate the mechanism of nesting of test files such as described in the foregoing with reference to FIG. 4.

A device adapted for employing the invention or part of the invention is illustrated in FIG. 5. Such a device is, for example, a calculator or a minicomputer.

Device 500 here comprises a communication bus 505 to which there are connected:
a central processing unit or microprocessor 510 (CPU, abbreviation for Central Processing Unit in English terminology);
a read-only memory 515 (ROM, acronym for Read Only Memory in English terminology) that can comprise the programs necessary for implementation of the invention;
a random-access memory or cache memory 520 (RAM, acronym for Random Access Memory in English terminology) comprising registers adapted for recording variables and parameters created and modified in the course of execution of the aforesaid programs; and
a communication interface 550 adapted for transmitting and receiving data to and from the controlled devices of the aircraft in order to monitor them and know their state;

Device 500 preferably also has the following components:
a screen 525 making it possible to display data such as depictions of commands and to serve as a graphical interface with the user who will be able to interact with the programs according to the invention, with the aid of a keyboard and a mouse 530 or another pointing device such as a touch screen or a remote control;
a hard disk 535 that can comprise the aforesaid programs and data processed or to be processed according to the invention; and
a memory card reader 540 adapted for receiving a memory card 545 and reading or writing therein data processed or to be processed according to the invention.

The communication bus permits communication and interoperability among the different components included in device 500 or connected thereto. The depiction of the bus is not limitative and, in particular, the central unit is able to communicate instructions to any component of device 500 directly or via another component of device 500.

The executable code of each program permitting the programmable device to implement the processes according to the invention can be stored, for example, on hard disk 535 or in read-only memory 515.

According to a variant, memory card 545 can contain data, in particular a table of correspondence between the events detected and the commands that can be requested, as well as the executable code of the aforesaid programs which, once read by device 500, is stored on hard disk 535.

According to another variant, the executable code of the programs will be able to be received, at least partially, via communication interface 550, to be stored in a manner identical to that described above.

More generally, the program or programs will be able to be loaded into one of the storage means of device 500 before being executed.

Central unit 510 is going to control and direct the execution of the instructions of portions of software code of the program or programs according to the invention, which instructions are stored on hard disk 535 or in read-only memory 515 or else in the other aforesaid storage components. During boot-up, the program or programs that are stored in a non-volatile memory, for example hard disk 535 or read-only memory 515, are transferred to random-access memory 520 which then contains the executable code of the program or programs according to the invention, as well as the registers for storing the variables and parameters necessary for implementation of the invention.

The communication apparatus comprising the device according to the invention also can be a programmed apparatus. This apparatus then contains the code of the computer program or programs for example set in an application-specific integrated circuit (ASIC).

Naturally, to satisfy specific needs, an individual competent in the field of the invention will be able to apply modifications in the foregoing description.

ANNEX

```
<?xml verslon=“1.0” ?>
< !-- Comments -->
<FILE Version=“01.00.00” Test_No=“1” date=“11/01/2008”
  time=“15:17:21”>
  <TEST_SCENARIO Title=“Scenario 1” Descriptlon=“Nominal functioning scenario
of an operational environment”>
    <ANALYSIS VCOM_ID=“12345” Type=“UDP” Comm_Port=“15000”
      Src_IP=“192.168.1.4” Dest_IP=“239.0.0.1”>
      <FUNCTIONAL Offset=“2” Length=“12” />
    </ANALYSIS>
    <FRAMES_FILE Rec_Frame=“Scn1\MyFile_record.cap” />
    <FRAMES_FILE RecFrame=“Scn1\MyReference_File.cap” />
    <RECORDING_TOOL Name=“Wlreshark” >
      <RUN Cmd_Line=“C:\Program Files\Wireshark\tshark.exe”
        Optlons=“−f ”Ip proto \udp“” />
    </RECORDING_TOOL>
    <TEST_TOOL Name=“VIPERE”>
      <RUN Cmd_Line=“D:\VIPERE.exe” Option=“test.vpj” />
      <WAIT_COMPLETION Msg_ID=“CONFIGURATION”
        Wait_Time=“30000” />
      <DO Msg_Ident=“MONITOR_ENA” Optlon=“151.157.005.002”
        Optlons=“TRUE” />
      <DO Msg_Ident=“ACTIVATION” Optlon=“” Options=“” />
      <WAIT_COMPLETION Msg_ID=“SCENARIO” Wait_Time=“30000” />
      <DO Msg_Ident=“IO_DIAGNOSTIC” Optlon=“151.157.005.002”
        Options=“” />
      <WAIT Wait_Time=“10000” />
      <DO Msg_Ident=“MONITOR_ENA” Option“=”151.157.005.002”
        Options=−“FALSE” />
    </TEST_TOOL>
    <TEST_TOOL Name=“VIPERE”>
      <DO Msg_Ident=“NAMES_DEF” Option=“151.157.005.002”
        Optlons=”” />
      <STOP />
    </TEST_TOOL>
    <RECORDING_TOOL Name=“Wireshark”>
      <STOP />
    </RECORDING_TOOL>
</TEST_SCENARIO>
<TEST_SCENARIO Title=“Scenarlo 2” Descriptlon=“Scenario permitting only
regressions of the message NAMES_DEF to be recorded”>
  <ANALYSIS VCOM_ID=“12345” Type=“UDP” Comm_Port=“15000”
      Src_IP=“192.168.1.2” Dest_IP=1239.0.0.1”>
      <FUNCTIONAL Offset=”2” Length=“12” />
      <DATING Offset=“2” />
      <INTEGER Offset=“13” Size=“4” Expected_Value=“125” Tolerance=“5”
        />
      <RESPONSE_TIME VCOM_ID_Resp=“54321” Expected_value=“150”
        tolerance=“15” />
      <FLOATING_POINT Offset=−“17” Size=“4” Expected_Value=“13”
          Tolerance=“8” />
    </ANALYSIS>
    <FRAMES_FILE Rec_Frame=“Scn2\MyFile_record.cap” />
    <FRAMES_FILE RecFrame=“Scn2\MyReference_File.cap” />
    <TEST_TOOL Name=“VIPERE”>
      <RUN Cmd_Line=“D:\VIPERE.exe@192.168.2.3” Option=“test.vpj”
          />
      <WAIT_COMPLETION Msg_ID=“CONFIGURATION”
        Wait_Time=“30000” />
      <DO Msg_Ident=“ACTIVATION” Option=“” Options=“ ” />
      <WAIT_COMPLETION Msg_ID=“SCENARIO” Wait_Time=“30000” />
      <DO Msg_Ident=“IO_DIAGNOSTIC” Optlon=“151.157.005.002”
        Options=“” />
      <LOOP Iter-No=“10”>
        <DO Msg_Ident=“DEACTIVATE” Option=“151.157.005.002”
          Optlons=“” />
      </LOOP>
      <WAIT Wait_Time=“10000” />
    </TEST_TOOL>
    <RECORDING_TOOL Name=“Wlreshark”>
      <RUN Cmd_Line=“C:\Program
        Files\Wireshark\tshark.exe@192.168.2.4” Options=“−f “ip
        proto \udp“” />
    </RECORDING_TOOL>
    <TEST_TOOL Name=“VIPERE”>
      <DO Msg_Ident=“NAMES_DEF” Option=“151.157.005,002”
        Options=“” />
      <STOP/>
    </TEST_TOOL>
    <RECORDING_TOOL Name=“Wlreshark”>
      <STOP/>
    </RECORDING_TOOL>
  </TEST_SCENARIO>
  <TEST_SCENARIO Title=“C:\REF\Test_Flash.xml” Descrlptlon=“Test module of
the flash component” />
</FILE>
```

1. A computer method for detecting non-regression of an input/output system (215) from at least one remote station (210) comprising at least one test tool, the said at least one test tool being adapted for executing at least one test command of the said at least one input/output system, the said at least one input/output system and the said at least one remote station each being connected to at least one network interface connected to a communication network (205), this method being characterized in that it comprises the following steps,
transmitting (315), to a recording device (230) connected to the said communication network, an instruction to record at least one datum circulating on the said communication network, the said at least one datum to be recorded corresponding to a result of execution of the said at least one test command of the said at least one test tool;
transmitting (320), to the said at least one remote station, an instruction to execute the said at least one test command of the said at least one test tool;
receiving the said at least one recorded datum;
receiving at least one reference datum, the said at least one reference datum corresponding to the expected result of execution of the said at least one test command of the said at least one test tool; and
analyzing (335) the said at least one recorded datum according to the said at least one reference datum.

2. A method according to claim 1, according to which the said analysis step comprises a step of comparing the said at least one recorded datum with the said at least one reference datum.

3. A method according to claim 1 or claim 2, additionally comprising a step of transmitting (305) a configuration instruction to the said at least one remote station in order to configure the said at least one test tool.

4. A method according to any one of the preceding claims, additionally comprising a step of transmitting (310) a configuration instruction to the said recording device in order to configure it.

5. A method according to any one of the preceding claims, additionally comprising a step of transmitting (305), to the said at least one remote station, an instruction to run the said at least one test tool.

6. A method according to any one of the preceding claims, additionally comprising a step of filtering (325) the said at least one recorded datum, the said at least one recorded datum being analyzed in response to the said step of filtering the said at least one recorded datum.

7. A method according to any one of the preceding claims, additionally comprising a step of filtering the said at least one recorded datum, the said at least one recorded datum being analyzed according to the said at least one reference datum in response to the said step of filtering the said at least one reference datum.

8. A method according to any one of the preceding claims, according to which at least one of the said steps is stored in the form of an instruction in a file of XML type, the interpretation of the said file being independent of the nature of the commands to test the said at least one test tool.

9. A device comprising means adapted for employing each of the steps of the method according to any one of the preceding claims.

10. A computer program comprising instructions adapted for employing each of the steps of the method according to any one of claims 1 to 8 when the said program is executed on a computer.
